(19) United States
(12) Patent Application Publication
(10) Pub. No.: US 2022/0399660 A1
(43) Pub. Date: Dec. 15, 2022

(54) ELECTRICAL SWITCH ADAPTOR

(71) Applicant: Joan Llopart Masana, Sant Pau d'Ordal (ES)

(72) Inventor: Joan Llopart Masana, Sant Pau d'Ordal (ES)

(73) Assignee: REMOTE CONTROL SOLUTIONS S.L., Sant Joan Despí (ES)

(21) Appl. No.: 17/342,725

(22) Filed: Jun. 9, 2021

(51) Int. Cl. H01R 12/59; H01R 27/02

(52) U.S. Cl. CPC H01R 12/592; H01R 27/02

(57) ABSTRACT

The presently disclosed subject matter provides an electrical switch adaptor for connecting an electrical switch to an electrical device. In a preferred embodiment, the electrical switch adaptor is configured for use with a PCB (Printed Circuit Board)-mounted tactile switch button. In some embodiments, the electrical switch adaptor is a flexible PCB strip comprising a first end designed to fit around, and electrically connect to, the tactile switch button body, and a second end designed for electrical connection to an electrical device. When the electrical switch adaptor is electrically connected to a switch button and to an electrical device, a user may operate the switch button via the electrical device.

### TECHNICAL FIELD

The presently disclosed subject matter relates generally to an electrical switch adaptor and more particularly to an electrical switch adaptor configured for an electrical attachment to a circuit board mounted tactile switch.

### BACKGROUND

Many electrical devices are turned on or off using a tactile switch button, which often has to be pressed, or otherwise operated, manually. In some instances, it is very advantageous to be able to remotely initiate the action of an electrical device, especially for the handicapped. However, many electrical devices, especially older devices, do not offer this possibility.

An example that comes to mind is remote opening of garage doors. Many garage doors open electrically, but necessitate a manual operation of garage door opener wall console button. In many cases, even when a remote operation of garage doors is available it necessitates the operator to be in the vicinity of the garage door opener, for example in a distance of up to twenty meters from it. However, often there's a need to open and close garage doors from afar. It could be to let in a visitor, delivery, domestic help, or simply to avoid waiting in the driveway for the garage door to open, which is especially meaningful when the house is located in a busy street.

To date, the main solution available is replacing the garage door opener with a model that enables a remote operation. However, for many people this is cost-prohibitive. Some external devices on the market are configured to work with selected models of garage door opener wall consoles to enable a remote operation of garage doors. But many users discover that these devices are not compatible with their wall consoles and therefore their need for a solution remains. The present disclosure provides an electrical switch adaptor for connecting an electrical switch to an electrical device of choice and methods of use thereof.

### SUMMARY

In accordance with the present invention, various embodiments of an electrical switch adaptor and methods of use thereof are disclosed. In one embodiment, the present disclosure provides an electrical switch adaptor for connecting an electrical tactile switch to an electrical device.

In some embodiments, the electrical switch adaptor comprises an electrical switch adaptor body, wherein the body comprises a top surface and a bottom surface and a signal carrying portion comprising an electrical circuit therethrough. The signal carrying portion extends from a first end to a second end of the electrical switch adaptor body.

In some embodiments, the first end comprises an opening of pre-determined dimensions, wherein the opening flanked by at least one contact pad disposed on the bottom surface of the electrical switch adaptor. In some embodiments, each contact pad is electrically connected to a first end of the electrical circuit.

In some embodiments, the second end comprises at least one electrical connector which is disposed on the top surface of the electrical switch adaptor body. In some embodiments, the at least one electrical connector is disposed on a location selected from a group comprising the top surface of the electrical switch adaptor body, the bottom surface of the electrical switch adaptor body, a side of the electrical switch adaptor body, or combinations thereof. In some embodiments, each electrical connector is electrically connected to a second end of the electrical circuit.

In some embodiments, the opening is flanked by four contact pads. In some embodiments, the four contact pads are metal pads. In some embodiments, the four contact pads are further carbon printed. In some embodiments, the opening is further flanked by four vias, each via electrically connected to a juxtaposed contact pad.

In some embodiments, the second end comprises two electrical connectors. In some embodiments, the two electrical connectors are metal pads. In some embodiments, the two electrical connectors can be electrically connected to an electrical device.

In some embodiments, the electrical circuit comprises electrical signal traces formed within the signal carrying portion.

In some embodiments, the electrical switch adaptor body comprises dielectric material. In some embodiments, the dielectric material is a flexible or a rigid material.

In some embodiments, the electrical switch is a circuit board mounted tactile switch button and the opening is configured for a close fit around the said circuit board mounted tactile switch button. In some embodiments, wherein the circuit board mounted tactile switch button is a standard push button switch.

In some embodiments, when the opening is fitted around the circuit board mounted tactile switch button, each contact pad rests upon a pin of the circuit board mounted tactile switch button and thus, the electrical switch adaptor is electrically connected to the said circuit board mounted tactile switch button.

In some embodiments, the present disclosure provides a method of connecting a circuit board mounted tactile switch button to an electrical device comprising the steps of:
a. fitting the opening of the presently disclosed electrical switch adaptor around the circuit board mounted tactile switch button so that each contact pad rests upon a pin of the circuit board mounted tactile switch button and thus the electrical switch adaptor is electrically connected to the circuit board mounted tactile switch button;
b. optionally, keeping the electrical switch adaptor in the position of step a by fitting an elastic band on top of the electrical switch adaptor's opening and around the circuit board mounted tactile switch button; and,
c. electrically connecting the electrical connectors of the electrical switch adaptor to the electrical device's wires, electrical port, or circuit board.

### BRIEF DESCRIPTION OF THE DRAWINGS

Having thus described the presently disclosed subject matter in general terms, reference will now be made to the accompanying Drawings, which are not necessarily drawn to scale, and wherein:

FIG. 1 illustrates a perspective top view of an embodiment of the presently disclosed electrical switch adaptor;

FIG. 2 illustrates a perspective bottom view of an embodiment of the presently disclosed electrical switch adaptor;

FIG. 3 illustrates an exploded view of a circuit board comprising a switch button, an embodiment of the presently disclosed electrical switch adaptor, and an elastic band;

FIG. 4 illustrates a perspective front view depicting the components of FIG. 3 in an assembled state;

FIG. 5 illustrates an exploded front view of a wall console comprising a circuit board and an embodiment of the presently disclosed electrical switch adaptor;

FIG. 6 illustrates an exploded back view of a wall console comprising a circuit board and an embodiment of the presently disclosed electrical switch adaptor;

FIG. 7 illustrates a perspective front view of an embodiment of a wall console in which the presently disclosed electrical switch adaptor is installed;

FIG. 8 illustrates a perspective back view of an embodiment of a wall console in which the presently disclosed electrical switch adaptor is installed;

FIG. 9 an exploded front view of another embodiment of a wall console comprising a circuit board, and an embodiment of the presently disclosed electrical switch adaptor;

FIG. 10 illustrates a perspective front view of an embodiment of the wall console of FIG. 9 in which the presently disclosed electrical switch adaptor is installed; and,

FIG. 11 illustrates a perspective back view of an embodiment of the wall console of FIG. 9 in which the presently disclosed electrical switch adaptor is installed.

### DETAILED DESCRIPTION

The presently disclosed subject matter now will be described more fully hereinafter with reference to the accompanying Drawings, in which some, but not all embodiments of the presently disclosed subject matter are shown. Like numbers refer to like elements throughout. The presently disclosed subject matter may be embodied in many different forms and should not be construed as limited to the embodiments set forth herein; rather, these embodiments are provided so that this disclosure will satisfy applicable legal requirements. Indeed, many modifications and other embodiments of the presently disclosed subject matter set forth herein will come to mind to one skilled in the art to which the presently disclosed subject matter pertains having the benefit of the teachings presented in the foregoing descriptions and the associated Drawings. Therefore, it is to be understood that the presently disclosed subject matter is not to be limited to the specific embodiments disclosed and that modifications and other embodiments are intended to be included within the scope of the appended claims.

The presently disclosed subject matter provides an electrical switch adaptor for connecting an electrical switch to an electrical device of choice and methods of use thereof. In a preferred embodiment, the electrical switch adaptor is configured for an electrical attachment to a circuit board (such as PCB—Printed Circuit Board) mounted tactile switch button. In some embodiments, the presently disclosed electrical switch adaptor is a flexible PCB, substantially planar, strip comprising a first end and a second end, and a signal carrying portion comprising an electrical circuit therebetween. The first end comprises an opening configured for a close fit around a tactile switch button body and at least one contact pads disposed on the bottom surface of the first end and flanking the opening. The contact pads are electrically connected to the electrical circuit of the signal carrying portion. A tactile switch button body, for example, a PCB-mounted tactile switch body, may be positioned inside the opening of the electrical switch adaptor, so that the contact pads rest upon the tactile switch button's pins and are electrically connected to them. The second end comprises at least one electrical connector/s. The electrical connectors are electrically connected to the electrical circuit of the signal carrying portion. Thus, the signal carrying portion electrically connects the contact pads to the electrical connectors. The electrical connectors may be further electrically connected to any electrical device of choice. In a preferred embodiment, the electrical switch adaptor comprises four contact pads and two electrical connectors.

When the electrical switch adaptor is electrically connected to a tactile switch button via the contact pads and to an electrical device of choice via the electrical connectors, a user can operate the tactile switch button via the electrical device of choice. If the electrical device enables remote operation (e.g. via a wireless network), then the tactile switch button may be operated remotely. Thus, the presently disclosed electrical switch adaptor provides the possibility to turn any hard-to-reach, or otherwise hard-to-operate, tactile switch into a remotely operated tactile switch.

Importantly, the presently disclosed electrical switch adaptor is designed to enable an easy installation even by a layman user, and thus presents a much-needed solution in the field.

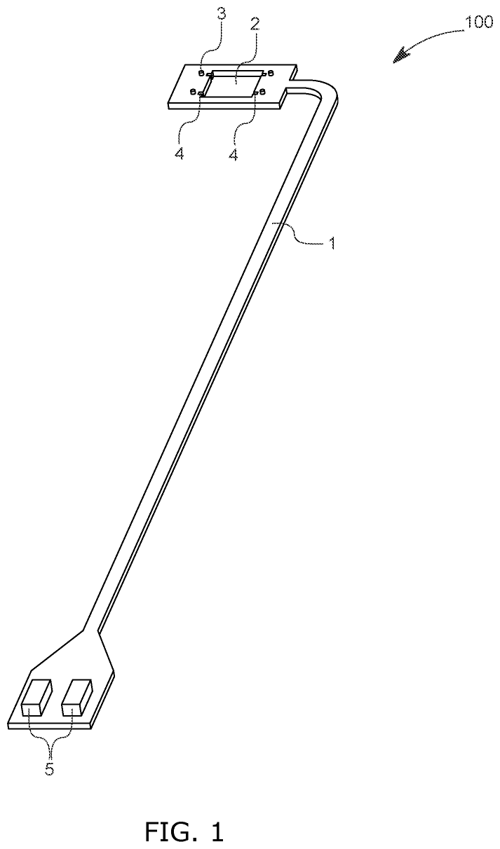

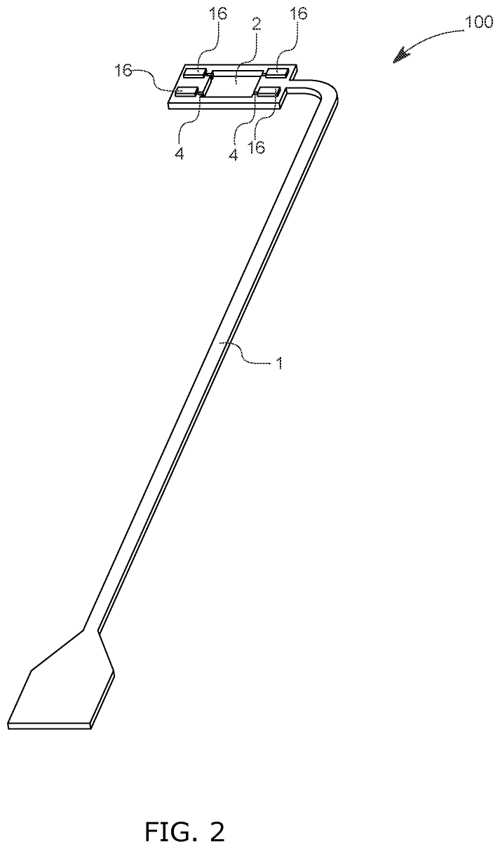

Referring now to FIGS. 1 and 2, top and bottom views of an embodiment of the presently disclosed electrical switch adaptor 100 are illustrated. In some embodiments, the electrical switch adaptor 100 of FIG. 1 is an elongated strip of a circuit board, for example a PCB strip. The electrical switch adaptor 100 comprises an electrical switch adaptor body 1. The electrical switch adaptor body 1 comprises a top surface (depicted in FIG. 1), a bottom surface (depicted in FIG. 2), a first end, and a second end. A signal carrying portion comprising an electrical circuit therethrough extends from the first end to the second end of the electrical switch adaptor body 1.

The first end comprises an opening 2 of pre-determined dimensions. The opening 2 is flanked by at least one contact pad 16 disposed on the bottom surface, each contact pad 16 is electrically connected to a first end of the electrical circuit of the signal carrying portion. The second end comprises at least one electrical connector 5 disposed on the top surface, each electrical connector is electrically connected to a second end of the electrical circuit of the signal carrying portion. In some embodiments, the electrical switch adaptor 100 comprises four contact pads 16 and two electrical connectors. In a preferred embodiment the at least one electrical connector 5 is disposed on the top surface of the presently disclosed electrical switch adaptor 100, the at least one electrical connector 5 may be positioned at the very edge/s of the second end, or further from the edge/s of the second end, or combinations thereof. In some other embodiments the position of the at least one electrical connector 5 may be selected from a group comprising the top surface, bottom surface, or sides of the electrical switch adaptor 100, or combinations thereof.

In some preferred embodiments, the opening 2 of the electrical switch adaptor is configured to fit snugly around the body 7 of a standard circuit board, such as a PCB, mounted tactile switch button 8, 7, 15. One skilled in the art will appreciate that a circuit board mounted tactile switch button 8, 7, 15 may be of various shapes and dimensions and that this variety of shapes and sizes is within the scope of the present disclosure. Therefore, the opening 2 may be of any shape and/or size, in accordance with the shape and/or size of the tactile switch body 7 of choice. For example, the opening 2 may be circular, elliptical, rectangular, or squarish. In a preferred embodiment (shown), the opening 2 is substantially squarish. In some embodiments, the opening dimensions are, or are about, 3.5×6, 4.5×4.5, 4.6×6.8, 4.2×6.0, 6×6, 5.2×5.2, 7.6×7.3, 8.1×8.1, 12×12, or 4.8×4.8 (as measured in millimeters).

In some embodiments, the frame of opening 2 further comprises at least one slit 4. The slit/s 4 are generally configured to align with the pin/s of the tactile switch button 8, 7, 15 of choice.

In some embodiments, the first end further comprises at least one via 3. Each via 3 is vertically aligned with, and electrically connected to, a corresponding contact pad 16. In a preferred embodiment, the first end comprises four vias 3. In accordance with their traditional use in the art, the via/s 3 are used herein to create a vertical, or layer-to-layer, electrical connection/s in the presently disclosed electrical switch adaptor 100. One skilled in the art will therefore appreciate that multiple configurations of size, placement, and type of via/s 3 are within the scope of the present disclosure. As a non-limiting example, the presently disclosed via/s 3 may be blind vias, buried vias, or through vias, or combinations thereof.

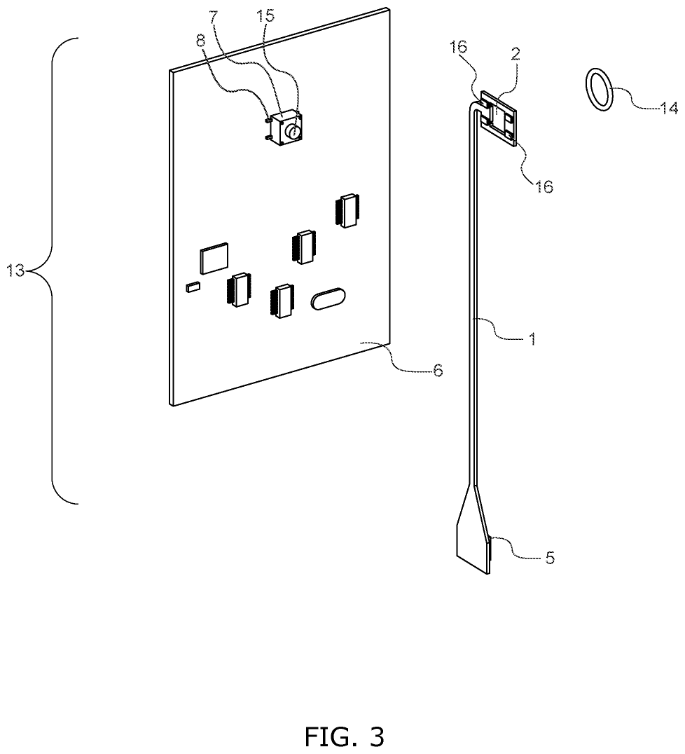

FIG. 3 is an exploded view depicting an assembly 13 comprising a circuit board 6 comprising a tactile switch button 8, 7, 15, an embodiment of the presently disclosed electrical switch adaptor 100, and an elastic band 14. In any of the embodiments described in the present disclosure the circuit board 6 may be a PCB. The PCB may be any standard PCB board, for example, it may be a garage door opener console PCB. The circuit board 6 mounted tactile switch button 8, 7, 15 comprises the tactile switch button body 7, the switch 15, and the pins 8. The switch may be any type of a mechanical tactile switch. Non limiting examples of types of mechanical tactile switches include a push button tactile switch (as depicted in FIG. 3), a toggle switch, slide switch, rotary switch, and rocker switch. In some preferred embodiments, the presently disclosed electrical switch adaptor 100 is designed for electrical coupling with any standard push button tactile switch 8, 7, 15. In any of the embodiments of the presently disclosed electrical switch adaptor 100, and for any type, and/or size, of a tactile switch, the opening's 2 dimensions and shape are configured for a close fit around the tactile switch body 7. Similarly, the placement, shape, dimensions, and number of the contact pads 16 is designed to allow each contact pad 16 an electrical connection, and physical contact, with each corresponding tactile switch button's pin 8.

To electrically connect the electrical switch adaptor 100 and the tactile switch button 8, 7, 15, a user fits the opening 2 around the tactile switch button body 7 so that each contact pad 16 rests upon a corresponding pin 8. The slits 4 adjust for the junctions of the pins 8 with the tactile switch button body 7, and allow the contact pads 16 to be easily placed in substantial physical contact with the pins 8. To secure the electrical switch adaptor 100 placement around the tactile switch button 8, 7, 15, a user may simply place an elastic band 14 on the electrical switch adaptor 100 and around the tactile switch button body 7.

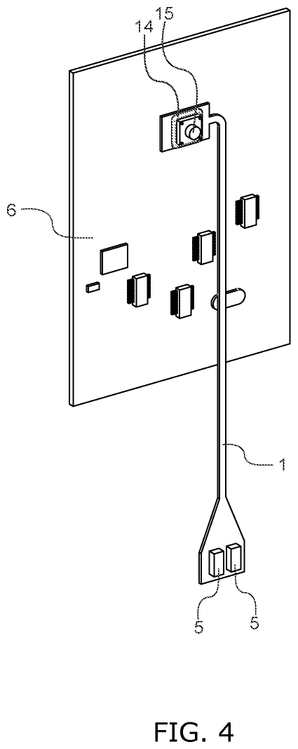

The assembly 13, of FIG. 3 is depicted in an assembled state in FIG. 4. In some embodiments, the signal carrying portion of the electrical switch adaptor 100 is significantly longer than the circuit board 6. In some embodiments, the length of the signal carrying portion is, or is about, in the range of 5-30 centimeters. In other embodiments, the length of the signal carrying portion is, or is about, in the range of 10-20 centimeters. In yet other embodiments, the length of the signal carrying portion is, or is about, 10, 11, 12, 13, 14, 15, 16, 17, 18, 19, or 20 centimeters. In some embodiments, any of the above-mentioned values may apply also to the length of the electrical switch adaptor 100. In some preferred embodiments, the length of the signal carrying portion is, or is about, 13.62 centimeters. In some other preferred embodiments, the length of the electrical switch adaptor 100 is, or is about, 13.62 centimeters.

The signal carrying portion comprises an electrical circuit (not shown) which electrically connects the contact pads 16 and the electrical connectors 5. The electrical circuit may be a standard electrical circuit traditionally used in printed circuit boards. For example, the electrical circuit may be electrical signal traces formed within, and/or on the surface of, the signal carrying portion. In a preferred embodiment, the electrical signal traces are formed within the signal carrying portion.

The electrical signal traces, contact pads 16, and electrical connectors 5 comprise, or are fashioned of, any electrically conductive material traditionally used in the art. For example, the electrical signal traces, contact pads 16, and electrical connectors 5 may comprise, or may be fashioned of, any suitable type of metal, plastic, or combinations thereof. Non limiting examples of suitable types of material include copper, aluminum, iron copper, various alloys, gold, palladium, silver, platinum, nickel, chromium, silver, any suitable plastic, or combinations thereof. In some embodiments, the contact pads 16 are carbon printed to potentially improve the electrical conductivity between the contact pads 16 and the pins 8.

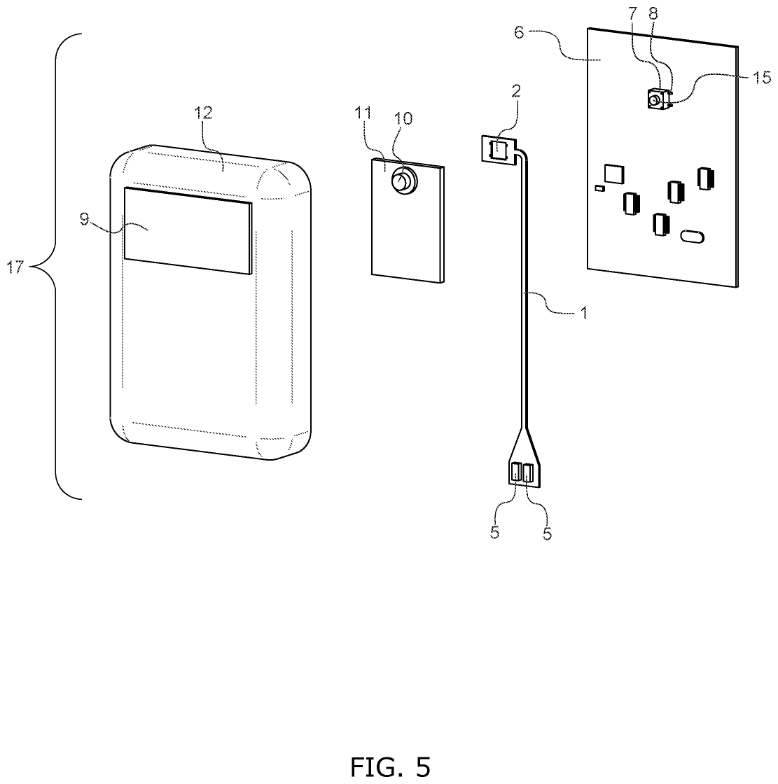

Referring now to FIG. 5, an exploded view illustrated the presently disclosed electrical switch adaptor 100 is illustrated as part of a wall console 17 assembly comprising a circuit board. In any of the embodiments described herein, a wall console may a garage door opener wall console. The electrical switch adaptor 100 is fitted on the tactile switch button 8, 7, 15, so that the opening 2 is around the tactile switch button body 7, and each contact pad 16 rests upon a corresponding pin 8. The slits 4 adjust for the junctions of the pins 8 with the tactile switch button body 7, and allow the contact pads 16 to be in a substantial physical contact with the pins 8.

In some embodiments, the wall console 17 comprises a cover 11 comprising a button cover 10, for example, a silicone button cover. The cover 11 is fitted on the circuit board 6 and the electrical switch adaptor 100 so that the button cover 10 is aligned with the switch 15, fitted onto it, and partly covers it. Therefore, the cover 11 and button cover secure the electrical switch adaptor 100 placement around the tactile switch button body 7 in which each contact pad 16 contacts a corresponding pin 8. In some other embodiments, wherein the wall console 17 does not comprise a cover 11, an elastic band 14 may be used to securing the electrical switch adaptor 100 placement around the tactile switch button body 7 in which each contact pad 16 contacts a corresponding pin 8.

A user can then fit the cover 12 of the wall console 17 to assemble the wall console 17 comprising the electrical switch adaptor 100. In some embodiments, the cover 12 comprises a button 9 which aligns with button cover 10 and switch 15. In other embodiments, wherein the wall console 17 does not comprise a cover 11 component, the button 9 may align directly with switch 15. In any of the above-described embodiments, operation of button 9 will operate switch 15.

In some other embodiments of the wall console 17, element 9 may be an opening of any shape and/or size. When element 9 is an opening, switch 15, whether or not covered with button cover 10, may be operated through the opening 9.

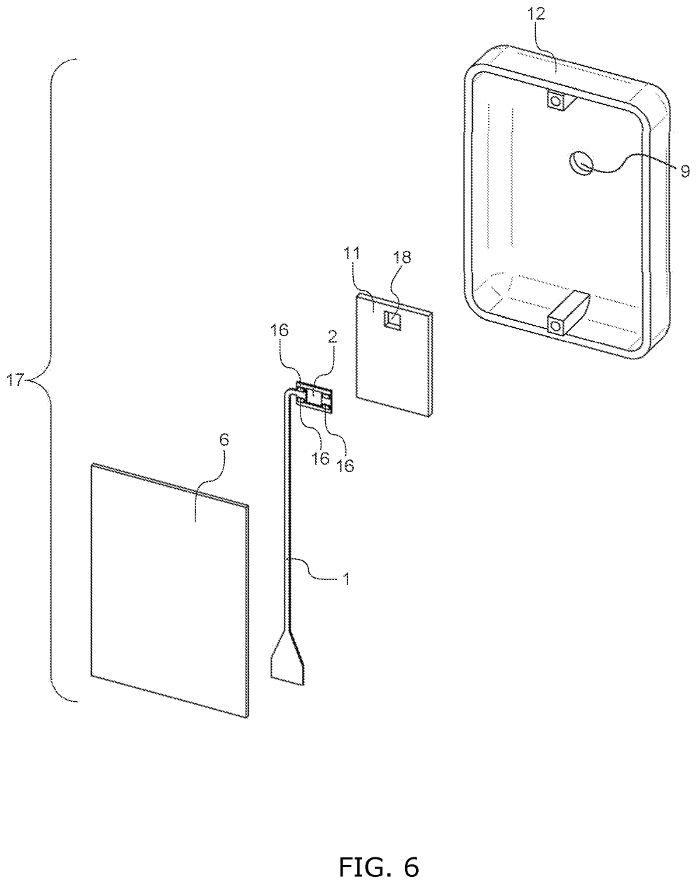

FIG. 6 depicts an exploded back view of an embodiment of a wall console 17 comprising an electrical switch adaptor 100. In the embodiment illustrated, the cover 11 comprises an opening 18. Upon assembly of the wall console 17, the opening is fitted around switch 15, and thus the cover 11 secures the electrical switch adaptor 100 placement around the tactile switch button body 7 in which each contact pad 16 rests upon a corresponding pin 8. Upon assembly of the wall console 17, opening 18 is aligned with opening 9 and switch 15 is accessible through both openings 18, 9 allowing operation by a user.

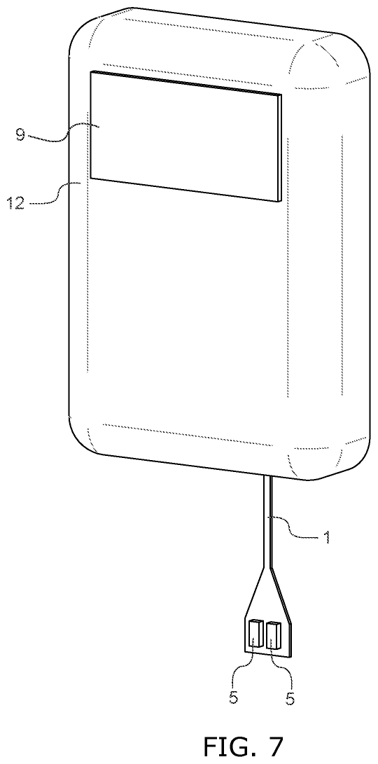

A front view of an embodiment of an assembled wall console 17 comprising the presently disclosed electrical switch adaptor 100 is illustrated in FIG. 7. A cover 12 is depicted, comprising a button, or an opening, 9. The second end of the electrical switch adaptor 100 comprising electrical connectors 5 and part of the signal carrying portion are outside of the wall console 17. The accessible electrical connectors 5 allow a user to electrically connect them to an electrical device of choice, for example, by connecting the electrical connectors to electrical wires of the electrical device of choice. A user may electrically connect the electrical connectors 5 to an electrical device using any method traditional in the art. For example, a user may electrically connect the electrical connectors 5 to circuit board mounted element/s, electrically connect the electrical connectors 5 to wires of an electrical device, or electrically connect the second end to an electrical port. Any method traditionally used in the art may be used to create electrical connection, such as without limitation, secured physical contact, soldering, crimping, or combinations thereof. Further, the electrical connector/s 5 may be any type of connectors known in the art for connecting a PCB to electrical wires. For example, the electrical connector/s 5 may have any suitable size, weight, shape, or orientation (including positioned in specific angles) to facilitate efficient connection with electrical wires. An electronic device electrically connected to the electrical connectors 5 is therefore electrically connected to the switch button 8, 7, 15, and may operate it. Depending on the type of the connected electrical device, the operation of the tactile switch button 8, 7, 15 may be a remote operation.

In embodiments wherein the wall console 17 is a garage door opener wall console a user may connect the electrical connectors 5 to electrical wires of an electrical device which controls the opening or closing of the garage doors. Therefore, the user will be able to control the garage door opener from the external, connected, electrical device. Thus, the presently disclosed electrical switch adaptor 100 serves as an electrical bridge between a garage door opener wall console and an electronic device of choice. Further, a person skilled in the art will appreciate that the presently disclosed electrical switch adaptor 100 may serve as an electrical bridge between any circuit board mounted tactile button and an electrical device of choice.

In some embodiments, manual operation of switch 15 may trigger an operation of an electrical device electrically connected to electrical connectors 5. For example, the operation may be, in the case of garage doors, a notification to a user that the garage doors are being opened, or closed. In some embodiments, manual operation of switch 15 does not trigger an operation of an electrical device electrically connected to electrical connectors 5.

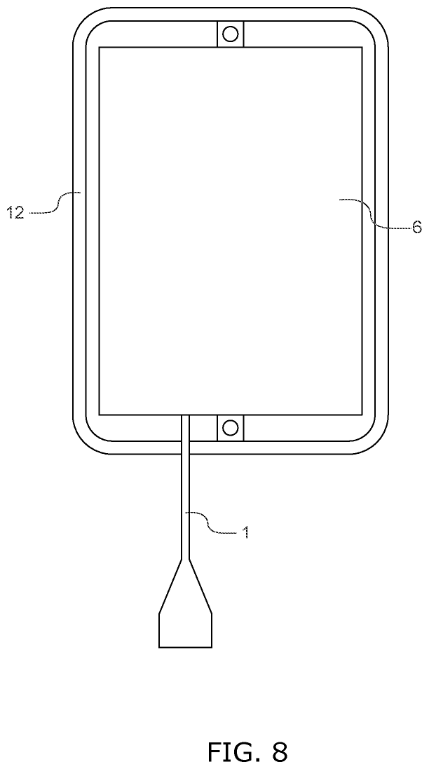

FIG. 8, illustrated a back view of an embodiment of an assembled wall console 17 comprising the presently disclosed electrical switch adaptor 100. The back side of the wall console 17 is depicted showing the back side of the circuit board 6 and the edges of the cover 12. The back surface of the second end of the electrical switch adaptor 100 is illustrated, extending outside the wall console 17.

In some embodiments, the body 1 of the electrical switch adaptor 100 comprises a dielectric material. In a preferred embodiment, the dielectric material is a flexible dielectric material. The dielectric material of the present disclosure may be any suitable material commonly used in the art. Non limiting examples of dielectric material include porcelain, mica, glass, plastics, and some metal oxides. In some preferred embodiments, the dielectric material of the present disclosure is a polymer, for example, Polyimide.

The flexibility, and thickness, of the electrical switch adaptor 100 allows it to be fitted around a tactile switch button body 7 without interfering with the ability to assemble/reassemble the wall console 17, or with the operation of tactile switch button 8, 7, 15. The flexibility, and thickness, of the electrical switch adaptor 100 also allows it to be partly placed in between the circuit board 6 and the cover 12, without preventing the possibility to assemble/reassemble the wall console 17.

One skilled in the art will appreciate that the presently disclosed electrical switch adaptor 100 may be of any thickness commonly used in the art. In some embodiments, the thickness of the presently disclosed electrical switch adaptor 100 may be in the range of 0.1-1.5 millimeters. In some other embodiments, the thickness of the presently disclosed electrical switch adaptor 100 may be, or may be about, 0.1, 0.2, 0.3, 0.4, 0.5, 0.6, 0.7, 0.8. 0.9, 1, 1.1, 1.2, 1.3, 1.4, or 1.5 millimeters.

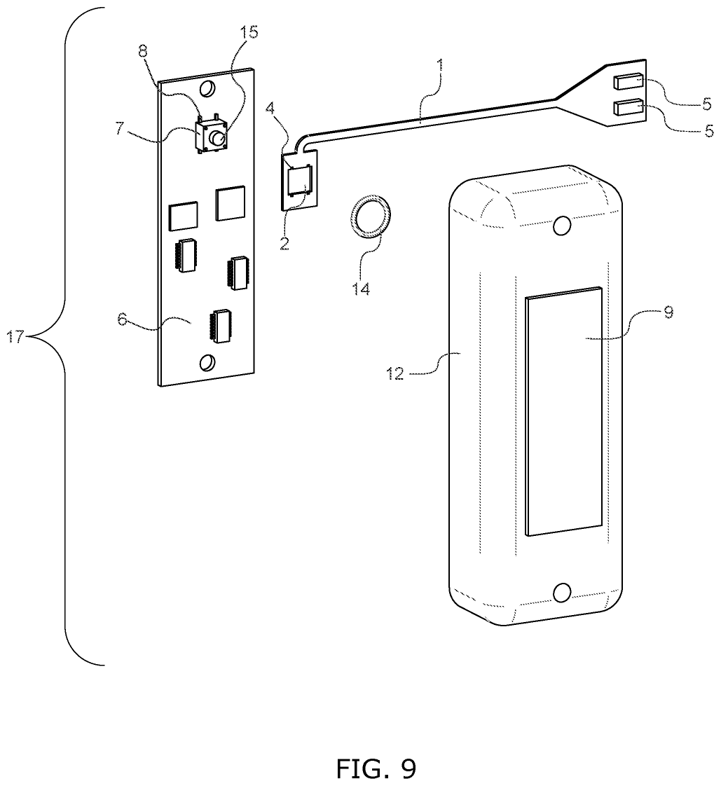

Referring now to FIG. 9, an exploded view of another embodiment of a wall console is illustrated, wherein the wall console 17 comprises an embodiment of the presently disclosed electrical switch adaptor 100. The circuit board 6 depicted in FIG. 9 comprises a tactile switch button 8, 7, 15, wherein the pins 8 extend vertically from the tactile switch button body 7. In other words, the tactile switch button 8, 7, 15 is mounted in a 90° degrees rotation in comparison to the mounting of the tactile switch button 8, 7, 15 of FIG. 3, necessitating a similar 90° degrees change in the position of the electrical switch adaptor 100, when installed. A user then can install the electrical switch adaptor 100 onto the tactile switch button 8, 7, 15 so that the opening 2 fits around the tactile switch button body 7, each contact pad 16 rests upon a corresponding pin 8, and the signal carrying portion extends horizontally from the circuit board 6. The slits 4 adjust for the junctions of the pins 8 with the tactile switch button body 7, and allow the contact pads 16 to be easily placed in substantial physical contact with the pins 8. To secure the electrical switch adaptor 100 placement around the tactile switch button body 7, a user may simply place an elastic band 14 on the electrical switch adaptor 100 and around the tactile switch button body 7, thus keeping the contact pads 16 and the pins 8 in physical contact and in electrical connection. Subsequently, the wall console 17 may be closed with the cover 12, and the tactile switch button 8, 7, 15 may be operated via button 9, or simply operate the switch 15 through opening 9.

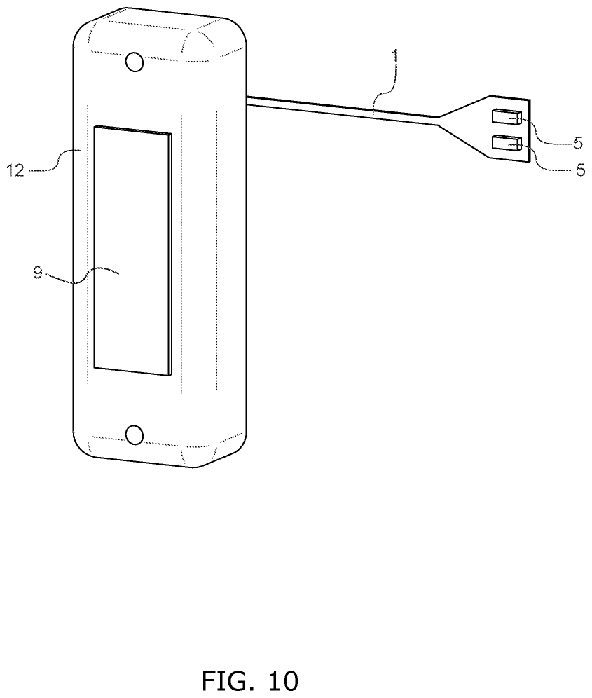

A front view of the assembled wall console 17 of FIG. 9 is illustrated in FIG. 10. The signal carrying portion is depicted extending outside of the wall console 17, and the second end comprising electrical connectors 5 is exposed and accessible for electrical connection to an electrical device.

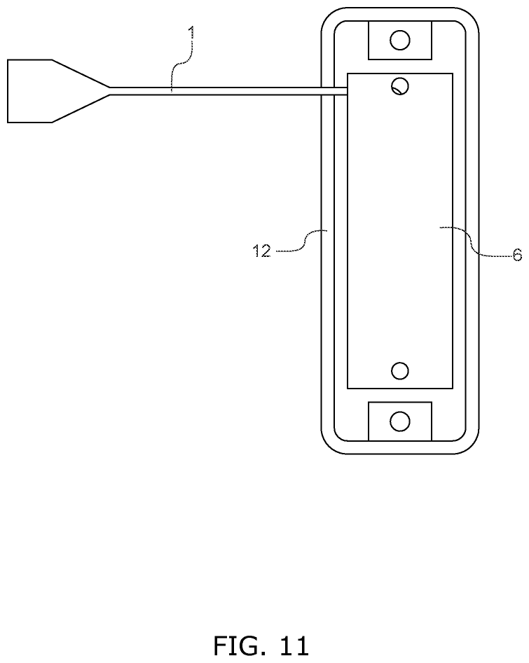

Finally, referring to FIG. 11, a back view of the assembled wall console 17 of FIG. 9 is illustrated. The signal carrying portion is depicted partly positioned in between the circuit board 6 and the cover 12, and extending outside of the wall console 17. The bottom surface of the second end comprising electrical connectors 5 is exposed.

Following long-standing patent law convention, the terms “a,” “an,” and “the” refer to “one or more” when used in this application, including the claims. Thus, for example, reference to “a subject” includes a plurality of subjects, unless the context clearly is to the contrary (e.g., a plurality of subjects), and so forth.

Throughout this specification and the claims, the terms “comprise,” “comprises,” and “comprising” are used in a non-exclusive sense, except where the context requires otherwise. Likewise, the term “include” and its grammatical variants are intended to be non-limiting, such that recitation of items in a list is not to the exclusion of other like items that can be substituted or added to the listed items.

For the purposes of this specification and appended claims, unless otherwise indicated, all numbers expressing amounts, sizes, dimensions, proportions, shapes, formulations, parameters, percentages, quantities, characteristics, and other numerical values used in the specification and claims, are to be understood as being modified in all instances by the term “about” even though the term “about” may not expressly appear with the value, amount or range. Accordingly, unless indicated to the contrary, the numerical parameters set forth in the following specification and attached claims are not and need not be exact, but may be approximate and/or larger or smaller as desired, reflecting tolerances, conversion factors, rounding off, measurement error and the like, and other factors known to those of skill in the art depending on the desired properties sought to be obtained by the presently disclosed subject matter. For example, the term “about,” when referring to a value can be meant to encompass variations of, in some embodiments, ±100% in some embodiments ±50%, in some embodiments ±20%, in some embodiments ±10%, in some embodiments ±5%, in some embodiments ±1%, in some embodiments ±0.5%, and in some embodiments ±0.1% from the specified amount, as such variations are appropriate to perform the disclosed methods or employ the disclosed compositions.

Further, the term “about” when used in connection with one or more numbers or numerical ranges, should be understood to refer to all such numbers, including all numbers in a range and modifies that range by extending the boundaries above and below the numerical values set forth. The recitation of numerical ranges by endpoints includes all numbers, e.g., whole integers, including fractions thereof, subsumed within that range (for example, the recitation of 1 to 5 includes 1, 2, 3, 4, and 5, as well as fractions thereof, e.g., 1.5, 2.25, 3.75, 4.1, and the like) and any range within that range.

Although the foregoing subject matter has been described in some detail by way of illustration and example for purposes of clarity of understanding, it will be understood by those skilled in the art that certain changes and modifications can be practiced within the scope of the appended claims.

That which is claimed:

1. An electrical switch adaptor for connecting an electrical tactile switch to an electrical device comprising:
an electrical switch adaptor body, the body comprising a top surface and a bottom surface and having a signal carrying portion comprising an electrical circuit therethrough, the signal carrying portion extending from a first end to a second end of the electrical switch adaptor body;
the first end comprising an opening of pre-determined dimensions, the opening flanked by at least one contact pad disposed on the bottom surface wherein each contact pad is electrically connected to a first end of the electrical circuit; and,
the second end comprising at least one electrical connector, the at least one electrical connector disposed on a location selected from a group comprising the top surface, the bottom surface, a side of the body, or combinations thereof; wherein each electrical connector is electrically connected to a second end of the electrical circuit.

2. The electrical switch adaptor of claim 1, wherein the opening is flanked by four contact pads.

3. The electrical switch adaptor of claim 2, wherein the four contact pads are metal pads.

4. The electrical switch adaptor of claim 3, wherein the four contact pads are further carbon printed.

5. The electrical switch adaptor of claim 3, wherein the opening is further flanked by four vias, each via electrically connected to a juxtaposed contact pad.

6. The electrical switch adaptor of claim 5, wherein the second end comprises two electrical connectors.

7. The electrical switch adaptor of claim 6, wherein the two electrical connectors can be electrically connected to an electrical device.

8. The electrical switch adaptor of claim 7, wherein the electrical circuit comprises electrical signal traces formed within the signal carrying portion.

9. The electrical switch adaptor of claim 8, wherein the electrical switch adaptor body comprises dielectric material.

10. The electrical switch adaptor of claim 9, wherein the dielectric material is a flexible or a rigid material.

11. The electrical switch adaptor of claim 10, wherein the electrical switch is a circuit board mounted tactile switch button and the opening of the electrical switch adaptor is configured for a close fit around the said circuit board mounted tactile switch button.

12. The electrical switch adaptor of claim 11, wherein the circuit board mounted tactile switch button is a standard push button switch.

13. The electrical switch adaptor of claim 11, wherein when the opening is fitted around the circuit board mounted tactile switch button, each contact pad rests upon a pin of the circuit board mounted tactile switch button and thus, the electrical switch adaptor is electrically connected to the said circuit board mounted tactile switch button.

14. A method of connecting a circuit board mounted tactile switch button to an electrical device comprising the steps of:
a. fitting the opening of the electrical switch adaptor of claim 13 around the circuit board mounted tactile switch button so that each contact pad rests upon a pin of the circuit board mounted tactile switch button and thus the electrical switch adaptor is electrically connected to the circuit board mounted tactile switch button;
b. optionally, keeping the electrical switch adaptor in the position of step a by fitting an elastic band on top of the electrical switch adaptor's opening and around the circuit board mounted tactile switch button; and,
c. electrically connecting the electrical connectors to the electrical device's wires, electrical port, or circuit board.
